(19) United States
(12) Patent Application Publication
(10) Pub. No.: US 2002/0121110 A1
(43) Pub. Date: Sep. 5, 2002

(54) Method of manufacturing glass substrate for information recording media and glass substrate manufactured using the method

(76) Inventors: Yasuhiro Saito, Takatukishi (JP); Kazuishi Mitani, Takarazuka (JP); Junji Kurachi, Takarazuka (JP)

Correspondence Address: FRISHAUF, HOLTZ, GOODMAN &, LANGER & CHICK, PC, 767 THIRD AVENUE, 25TH FLOOR, NEW YORK, NY, 10017-2023, US

(21) Appl. No.: 09/993,173

(22) Filed: Nov. 5, 2001

(30) Foreign Application Priority Data
Nov. 6, 2000 (JP) 2000-337434

(51) Int. Cl. C03C 21/00

(52) U.S. Cl. 65/30.14

(57) ABSTRACT

There are provided a method of manufacturing a glass substrate for information recording media that is capable of manufacturing a glass substrate for information recording media having excellent smoothness and cleanliness as required for a disk substrate, and a glass substrate for information recording media manufactured using the method. A glass substrate is subjected to precision polishing. The glass substrate is then subjected to first washing treatment using an acidic aqueous solution and an alkaline aqueous solution, then subjected to heat treatment, and then subjected to second washing treatment once again using an acidic aqueous solution and an alkaline aqueous solution. As a result, foreign matter such as polishing agent can be removed almost completely through the first washing treatment, then permanent strain generated during the polishing can be relaxed through the heat treatment, and then surface undulations remaining on the surface of the glass substrate can be removed through the second washing treatment. A glass substrate for information recording media having excellent surface smoothness and cleanliness can thus be manufactured.

### BACKGROUND OF THE INVENTION

1. Field of the Invention

The present invention relates to a method of manufacturing a glass substrate for information recording media, and more specifically to a method of manufacturing a glass substrate for information recording media such as a magnetic disk requiring excellent smoothness and cleanliness, and a glass substrate for information recording media manufactured using the method.

2. Prior Art

In recent years, there has been remarkable progress in information technology, and development of various types of information recording device for storing information has been carried out with vigor. Hard disk drives (hereinafter abbreviated to “HDDs”) form the mainstream of such information recording devices.

In an HDD, recording and playback of information is carried out by means of a magnetic head flying over a data zone formed on a disk substrate. Well-known driving methods used are the CSS (contact start/stop) method and the ramp load method.

In the CSS method, a CSS zone in which uniform minute undulations of height several tens of nm are formed is provided along the inner periphery or the outer periphery of the disk substrate. The magnetic head flies over the data zone of the disk substrate while the disk substrate is rotating, and slides over the CSS zone of the disk substrate when the disk substrate stops or starts up.

In the ramp load method, the magnetic head flies over the disk substrate while the disk substrate is rotating, and is stored in a predetermined storage position when the disk substrate stops.

In both the CSS method and the ramp load method, while the disk substrate is rotating, the magnetic head is thus raised up slightly from the surface of the disk substrate, and flies over the surface of the disk substrate with a gap (hereinafter referred to as the ‘flying height’) of several tens of nm maintained between the magnetic head and the surface of the disk substrate.

As the amount of information stored has increased enormously in recent years, there have been calls for HDDs that are small but have a large storage capacity, and hence it has become necessary to increase the recording density of the data zone, which is the information recording region. To increase the recording density of the information recording region, it is necessary to reduce the flying height. Glass materials have thus become widely used as disk substrate materials, since it is relatively easy to make a glass material into a small, thin plate, and the surface smoothness is excellent, and hence the flying height can be made low.

A glass substrate to be used as a disk substrate is generally manufactured by carrying out coarse grinding and fine polishing, and then carrying out chemical strengthening treatment by ion exchange to improve the shock resistance and the vibration resistance.

However, during the sequence of manufacturing steps, metal powder such as iron or stainless steel powder, and also molten salt used in the chemical strengthening treatment, may become attached to the surface of the glass substrate, and moreover a polishing agent (loose abrasive grains) used in the polishing may become embedded in or fixed firmly to the surface of the glass substrate in places, resulting in a large number of minute projections being formed on the surface of the glass substrate.

If such projections are present on the glass substrate, then there is a fear that when the glass substrate is rotated at high speed during use as an information recording medium in an information recording device, the magnetic head may collide with the projections resulting in head crashes, or thermal asperity may occur in which collisions between the magnetic head and the projections causes generation of heat which results in the magnetic head detecting an abnormal signal and hence in malfunctioning. In particular, in recent times high-sensitivity MR (magnetic resistance) heads and GMR (gigantic magnetic resistance) heads have become the mainstream, and there are thus calls for glass substrates allowing thermal asperity to be avoided more reliably.

With the above in view, art in which a glass substrate that has been precision polished is washed with hydrochloric acid to remove metal powder attached to the glass substrate has already been proposed (Japanese Laid-open Patent Publication (Kokai) No. 10-228643; hereinafter referred to as “prior art 1”).

Moreover, art in which a glass substrate that has been subjected to chemical strengthening treatment in a molten salt is washed with a cleaning agent containing an acid such as sulfuric acid or phosphoric acid to remove molten salt attached to the glass substrate has also been proposed (Japanese Laid-open Patent Publication (Kokai) No. 9-22525; hereinafter referred to as “prior art 2”).

According to prior art 1 described above, metal powder attached to a glass substrate can be removed by washing the glass substrate with hydrochloric acid, and according to prior art 2 described above, molten salt attached to a glass substrate can be removed by washing the glass substrate with an acid such as sulfuric acid or phosphoric acid. However, there is a problem in that residual foreign matter such as polishing agent from the polishing embedded in or fixed firmly to the surface of the glass substrate in places cannot be removed sufficiently, and hence projections remain on the glass substrate and the desired cleanliness cannot be obtained.

A means that can be envisaged for solving this problem is to etch the glass substrate after precision polishing, using an acidic aqueous solution that has a powerful etching action on glass such as an aqueous solution of hydrofluoric acid or silicofluoric acid, thus removing residual foreign matter such as polishing agent embedded in or fixed firmly to the glass substrate. However, if a chemical solution having a powerful etching action is used to remove residual foreign matter, then a new problem will arise, namely the surface roughness Ra will increase and hence the surface smoothness will worsen. That is, if the glass substrate is etched using an acidic aqueous solution that has a powerful etching action on glass such as an aqueous solution of hydrofluoric acid or silicofluoric acid, then although residual foreign matter is removed by the etching, the surface roughness Ra of the glass substrate increases and projections are formed on the surface of the glass substrate, resulting in a new problem of head crashes and thermal asperity as described above becoming liable to occur.

### SUMMARY OF THE INVENTION

In view of the problems described above, it is an object of the present invention to provide a method of manufacturing a glass substrate for information recording media that is capable of manufacturing a glass substrate for information recording media having excellent smoothness and cleanliness as required for a disk substrate, and a glass substrate for information recording media manufactured using the method.

To attain the above object, the present invention provides a method of manufacturing a glass substrate for information recording media, comprising the steps of precision polishing a glass substrate, then subjecting the glass substrate to first washing treatment using an acidic aqueous solution and an alkaline aqueous solution, then subjecting the glass substrate to heat treatment, and then subjecting the glass substrate to second washing treatment once again using an acidic aqueous solution and an alkaline aqueous solution. As a result, foreign matter such as polishing agent can be removed almost completely through the first washing treatment, then permanent strain generated during the polishing can be relaxed through the heat treatment, and then surface undulations remaining on the surface of the glass substrate can be removed through the second washing treatment. A glass substrate for information recording media having excellent surface smoothness and cleanliness can thus be manufactured. Moreover, in the first and second washing treatment before and after the heat treatment, washing with the acidic aqueous solution and washing with the alkaline aqueous solution are carried out in that order, and hence reattachment to the substrate surface of foreign matter removed from the substrate surface through the etching can be prevented, and thus a glass substrate for information recording media having a yet better cleanliness can be obtained.

Preferably, the treatment temperature of the heat treatment is not less than (T−200)° C., wherein T represents an annealing temperature corresponding to a strain-removing point of the glass substrate (hereinafter referred to as “the strain-removing point”). As a result, permanent strain can be relaxed efficiently, and polishing marks can be removed.

The strain-removing point is a temperature at which a glass substrate is soaked for a rather short time (about 15 minutes) to remove permanent strain and at which the viscosity of the glass substrate becomes 2.5×10 Pa·sec (2.5×10¹³ poise). The strain-removing point is determined the chemical composition of the glass substrate.

Alternatively, the treatment temperature of the heat treatment is not more than T° C. As a result, warping of the glass substrate does not occur, and permanent strain can be relaxed reliably.

Also preferably, the heat treatment is carried out in a liquid. As a result, the controllability increases due to the high thermal capacity, and hence permanent strain can be relaxed yet more reliably.

More preferably, the liquid is a molten salt, and the heat treatment thus includes chemical strengthening treatment wherein some ions of chemical components constituting the glass substrate are replaced with ions contained in the molten salt having a larger ionic radius than the above-mentioned ions of the chemical components constituting the glass substrate. As a result, chemical strengthening treatment need not be carried out as a separate manufacturing step, and hence the manufacturing process can be simplified and the manufacturing cost reduced. Moreover, the surface compressive stress is increased through the chemical strengthening treatment, and hence the glass substrate can be prevented from breaking when used as a magnetic disk and rotated at high speed.

Also preferably, the acidic aqueous solution contains at least one acid selected from the group consisting of hydrofluoric acid, silicofluoric acid, sulfuric acid, hydrochloric acid, nitric acid, sulfamic acid, and phosphoric acid. As a result, the surface of the glass substrate can be etched efficiently.

Also preferably, the alkaline aqueous solution comprises an aqueous solution of a water-soluble alkaline material, and further contains at least one component selected from the group consisting of surfactants and chelating agents. As a result, the washing effects can be improved.

Further, to attain the above object, the present invention provides a glass substrate for information recording media manufactured using the above-described method according to the present invention.

The above and other objects, features and advantages of the invention will become more apparent from the following detailed description taken in conjunction with the accompanying drawings.

### BRIEF DESCRIPTION OF THE DRAWINGS

The single FIGURE is a flow chart of a manufacturing process for a glass substrate 1 according to an embodiment of the present invention.

### DETAILED DESCRIPTION OF PREFERRED EMBODIMENTS

Embodiments of the present invention will now be described in detail.

An aluminosilicate glass having a chemical composition of 55 to 70 mol % of SiO₂, 1 to 12.5 mol % of Al₂O₃, 5 to 20 mol % of Li₂O, 0 to 14 mol % of Na₂O, 0 to 3 mol % of K₂O, 0to 8 mol % of MgO, 0 to 10 mol % of CaO, 0 to 6 mol % of SrO, 0 to 2 mol % of BaO, 0 to 8 mol % of TiO₂ and 0 to 4 mol % of ZrO₂ is used as a glass substrate 1, which is the glass substrate for information recording media according to the present embodiment.

The reasons for setting the above ranges for the chemical composition are as follows.

SiO₂ is the principal constituent of the glass. If the SiO₂ content is less than 55 mol %, then the durability of the glass will worsen, whereas if the SiO₂ content is greater than 70 mol %, then the viscosity will become too high and hence melting will become difficult. The SiO₂ content in the present embodiment was thus set to 55 to 70 mol %.

Al₂O₃ is a component that increases the rate of ion exchange during chemical strengthening treatment, and increases the durability of the glass. Moreover, Al₂O₃ readily leached out by acidic aqueous solutions, resulting in promotion of etching by acidic aqueous solutions. However, if the Al₂O₃ content is less than 1 mol %, then the desired effects will not be exhibited, whereas if the Al₂O₃ content is greater than 12.5 mol %, then the viscosity will become too high and the devitrification resistance will drop, and hence melting will become difficult. The A₂O₃ content in the present embodiment was thus set to 1 to 12.5 mol %.

Li₂O is an alkali metal oxide. The lithium ions in Li₂O are replaced with alkali metal ions having a larger ionic radius than the lithium ions during chemical strengthening treatment. Li₂O also increases the meltability during glass melting, and moreover is readily leached out by acidic aqueous solutions, resulting in promotion of etching by acidic aqueous solutions. However, if the Li₂O content is less than 5 mol %, then the surface compressive stress after the ion exchange will be insufficient, and moreover the viscosity will rise and hence melting will become difficult. Moreover, if the Li₂O content is greater than 20 mol %, then the chemical durability will worsen. The Li₂O content in the present embodiment was thus set to 5 to 20 mol %.

As with Li₂O, Na₂O is an alkali metal oxide. The sodium ions in Na₂O are replaced with alkali metal ions having a larger ionic radius than the sodium ions during chemical strengthening treatment. Na₂O also increases the meltability during glass melting, and moreover is readily leached out by acidic aqueous solutions, resulting in promotion of etching by acidic aqueous solutions. However, if the Na₂O content is greater than 14 mol %, then the chemical durability will worsen. The Na₂O content in the present embodiment was thus set to 0 to 14 mol %.

K₂O is also an alkali metal oxide. K₂O increases the meltability during glass melting, and moreover promotes leaching out by acidic aqueous solutions, resulting in promotion of etching by acidic aqueous solutions. However, if the K₂O content is greater than 3 mol %, then the chemical durability will worsen. The K₂O content in the present embodiment was thus set to 0 to 3 mol %.

MgO is an alkaline earth metal oxide. MgO increases the meltability of the glass, and also promotes etching by acidic aqueous solutions. However, if the MgO content is greater than 8 mol %, then the liquid phase temperature of the glass will increase, and the devitrification resistance will worsen. The MgO content in the present embodiment was thus set to 0 to 8 mol %.

As with MgO, CaO is an alkaline earth metal oxide. CaO increases the meltability of the glass, and also promotes etching by acidic aqueous solutions. However, if the CaO content is greater than 10 mol %, then the liquid phase temperature of the glass will increase, and the devitrification resistance will worsen. The CaO content in the present embodiment was thus set to 0 to 10 mol %.

As with CaO and MgO, SrO and BaO are alkaline earth metal oxides which increase the meltability of the glass, and also promote etching by acidic aqueous solutions. However, it is undesirable for the SrO content to be greater than 6 mol % or the BaO content to be greater than 2 mol %, since then the specific gravity of the glass substrate will become too high. The SrO content in the present embodiment was thus set to 0 to 6 mol %, and the BaO content to 0 to 2 mol %.

TiO₂ is a component that increases the chemical durability of the glass. However, if the TiO₂ content is greater than 8 mol %, then the liquid phase temperature of the glass will increase, and the devitrification resistance will worsen. The TiO₂ content in the present embodiment was thus set to 0 to 8 mol %.

ZrO₂ is a component that increases the chemical durability of the glass. However, if the ZrO₂ content is greater than 4 mol %, then there is a risk of the ZrO₂ precipitating as microcrystals during melting of the glass. The ZrO₂ content in the present embodiment was thus set to 0 to 4 mol %.

It should be noted that, although an aluminosilicate glass having a composition as described above is used as the glass substrate 1 in the present embodiment, the present invention is not limited to such an aluminosilicate glass. For example, a soda lime glass having SiO₂, alkali metal oxides and alkaline earth metal oxides as principal components, a borosilicate glass having SiO₂ and boron oxide as principal components, an Li₂O—SiO₂ glass having Li₂O and SiO₂ as principal components, an Li₂O—Al₂O₃—SiO₂ glass having Li₂O, SiO₂ and Al₂O₃ as principal components, or an RO—Al₂O₃—SiO₂glass (R=Mg, Ca, Sr, Ba, Zn, Ni, Mn etc.) having alkaline earth metal oxides or the like, Al₂O₃ and SiO₂ as principal components can also be used.

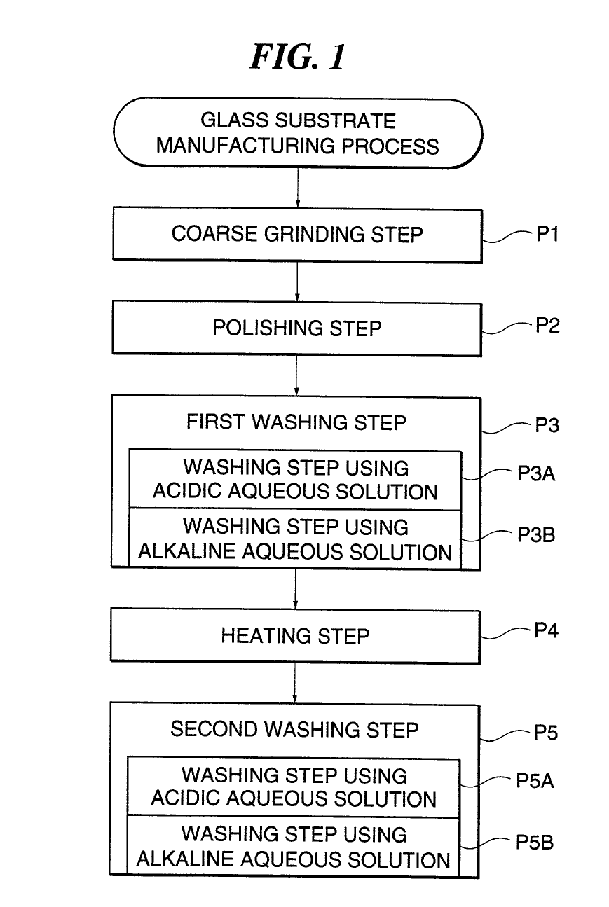

FIG. 1 is a flow chart of the manufacturing process for the glass substrate 1.

The glass substrate 1 is first coarsely ground approximately to predetermined dimensions (step P1 ), and is then polished (step P2). In the polishing step, surfaces of the glass substrate 1 are precision polished using a polishing agent comprised of loose abrasive grains dispersed in a polishing liquid.

There are no particular limitations on the type of the loose abrasive grains, but to obtain an excellent surface smoothness as required of a substrate for information recording media, it is preferable to use cerium oxide (CeO₂), manganese oxide, zirconium oxide (zirconia), titanium oxide (titania), SiO₂, or diamond abrasive grains.

Moreover, there are no particular limitations on the diameter of the loose abrasive grains, but to obtain an excellent surface smoothness and sufficient polishing rate, it is preferable to use loose abrasive grains having a diameter of 0.01 to 3 μm.

Moreover, there are no particular limitations on the polishing method. However, it is preferable to use a both-surface polishing machine in which a suede type polishing pad made of artificial leather is affixed to each of an upper plate and a lower plate, since then both surfaces of the glass substrate can be precision polished at low cost.

Next, a first washing step (step P3) is carried out. This step is comprised of a washing step using an acidic aqueous solution (step P3A), and a washing step using an alkaline aqueous solution (step P3B).

In step P3A the glass substrate 1 is washed with an acidic aqueous solution, whereby components of the glass substrate 1 are leached out. The surface of the glass substrate 1 thus becomes rich in SiO₂, which is the skeletal component of the glass substrate 1. SiO₂ is soluble in alkaline aqueous solutions, and hence after the glass substrate 1 has been washed with the acidic aqueous solution, the surface of the glass substrate 1 can be easily etched by washing with an alkaline aqueous solution.

When the glass substrate 1 is washed with an alkaline aqueous solution (step P3B) after washing with the acidic aqueous solution (step P3A), polishing agent embedded in or fixed firmly to the surface of the glass substrate 1 in places is thus readily removed by etching, and moreover the amount of etching can be suitably controlled. Furthermore, the alkaline aqueous solution also has an action of removing polishing agent that reattached to the glass substrate 1 during washing in the acidic aqueous solution. As a result, the polishing agent can be removed from the glass substrate almost completely.

There are no particular limitations on the acidic aqueous solution. However, although it is possible to use a weak acid such as acetic acid, it is preferable from the standpoint of promoting etching of the surface of the glass substrate to use a strong acid that has a powerful etching action on glass such as hydrofluoric acid, silicofluoric acid, sulfuric acid, hydrochloric acid, nitric acid, sulfamic acid or phosphoric acid.

Moreover, there are no particular limitations on the alkaline aqueous solution. An aqueous solution of any water-soluble alkaline material, for example potassium hydroxide, sodium hydroxide, ammonia or trimethylammonium hydride, can be used. Moreover, to improve the washing effects, it is preferable to add at least one component selected from surfactants, chelating agents and commercially sold synthetic alkaline cleaning agents.

There are no particular limitations on the concentrations of the acidic aqueous solution and the alkaline aqueous solution. Concentrations required for removing polishing agent from the glass substrate 1 can be selected as appropriate, with consideration being given to the chemical resistance of the glass substrate. However, if the amount of etching is made excessively high, then there will be a risk of parts of the glass substrate such as edge parts changing in shape. It is thus preferable to keep the amount of etching down to no more than 30 nm, and thus to adjust the concentrations of the acidic aqueous solution and the alkaline aqueous solution accordingly.

Moreover, there are no particular limitations on the washing time or the washing temperature. The washing time and the washing temperature can be determined as appropriate in accordance with the concentration of the acidic/alkaline aqueous solution and the etching rate of the glass substrate 1. Nevertheless, in view of factors such as the manufacturing cost, it is preferable for the washing time to be in a range of 1 minute to 20 minutes, and the washing temperature not more than 70° C.

The washing method generally used is to immerse the glass substrate 1 in the acidic aqueous solution in step P3A, and in the alkaline aqueous solution in step P3B.

Moreover, the washing is preferably carried out while irradiating the glass substrate 1 with ultrasound. The irradiation of the ultrasound may be carried out at one fixed frequency, or ultrasound of a plurality of different frequencies may be applied simultaneously, or the frequency of the ultrasound may be varied over time. Moreover, there are no particular limitations on the output power of the ultrasound, although in general the lower the frequency and the higher the output power, the greater the damage to the glass substrate 1, and hence the output power is preferably determined while considering this point.

In addition to the immersion method described above, a shower method, a spraying method or the like may be used as the washing method. In such a case, it is preferable to scrub the glass substrate 1 with a sponge or the like.

After the glass substrate 1 has been washed with the acidic aqueous solution and the alkaline aqueous solution as described above, the glass substrate 1 is dried.

There are no particular limitations on the drying method. For example, an IPA vapor drying method in which the glass substrate 1 is immersed in isopropyl alcohol (IPA) vapor, or a spin-drying method in which the washing solution is removed by rotating the glass substrate 1 at high speed, can be used.

Because the surface of the glass substrate 1 is etched in the first washing step (step P3) as described above, polishing agent and also other foreign matter such as iron powder that has become attached to the glass substrate 1 during the manufacturing process can be removed effectively.

Next, the glass substrate 1 is subjected to heat treatment (step P4), thus relaxing permanent strain that has been generated in the surface of the glass substrate 1 and hence removing polishing marks. Specifically, when the glass substrate 1 is polished using loose abrasive grains as described above, compressed layers are formed on the surface of the glass substrate 1 in places due to pressure during the polishing, and these compressed layers become polishing marks and remain as permanent strain. The chemical resistance is higher, and hence etching occurs less readily, in polishing mark parts in which polishing marks have been formed than in non-polishing-mark parts in which polishing marks have not been formed. The etching rate is thus different between the polishing mark parts and the non-polishing-mark parts, and hence although polishing agent embedded in or fixed firmly to the surface of the glass substrate 1 in places is removed in the first washing step (step P3), the etching is not uniform, and hence the surface roughness Ra of the glass substrate 1 increases, and thus the surface smoothness worsens. Heat treatment is thus carried out in a heating step (step P4) to relax the permanent strain and remove the polishing marks, and then the glass substrate 1 is again washed with an acidic aqueous solution and an alkaline aqueous solution in a second washing step (step P5), as described later, whereby surface undulations on the glass substrate 1 can be removed.

In the present embodiment, the heat treatment temperature is set between (T−200)° C. and T ° C., where T represents the strain-removing point. The reason for this is as follows: The permanent strain can be relaxed by maintaining the heat treatment temperature at the strain-removing point T for 15 minutes or more. However, if the heat treatment is carried out at a temperature above the strain-removing point T, then there will be a risk of the glass substrate 1 warping, and hence it is preferable for the heat treatment temperature to be set to no more than T° C. On the other hand, to remove the permanent strain easily in a short time, the heat treatment temperature should be as high as possible, and hence it is preferable for the heat treatment temperature to be set to not less than (T−200)° C. In the present embodiment, the heat treatment temperature is thus set between (T−200)° C. and T° C., where T is the strain-removing point.

The heat treatment time is set as appropriate in accordance with the heat treatment temperature.

There are no particular limitations on the heating means, and it is possible to carry out the heat treatment in either a gas or a liquid. However, it is preferable to carry out the heat treatment in a liquid, since then the thermal capacity is higher than if the heat treatment is carried out in a gas, and hence the controllability improves.

Moreover, if the heat treatment is carried out in a liquid, then it is preferable to use a molten salt as the liquid. If, for example, a mixture of potassium nitrate (KNO₃) and sodium nitrate (NaNO₃) is used as the molten salt, then chemical strengthening treatment is carried out in which ions such as Li⁺ and Na⁺ in the chemical components of the glass substrate 1 are replaced through ion exchange with K⁺, which has a larger ionic radius than Li⁺ and Na⁺. By carrying out such chemical strengthening treatment, the surface compressive stress of the glass substrate 1 can be increased, and hence breakage of a magnetic disk manufactured using the glass substrate 1 during rotation at high speed can be prevented. Moreover, if the heat treatment and chemical strengthening treatment are combined as described above, then chemical strengthening treatment need not be carried out as a separate step, and hence the manufacturing process can be simplified and the imanufacturing cost reduced.

It should be noted that if the heating step (step P4) were carried out without carrying out the first washing step (step P3) beforehand, then the heat treatment would be carried out in a state in which polishing agent still remained on the surface of the glass substrate 1, and hence the polishing agent would become firmly attached to the surface of the glass substrate 1. In this case, even if the second washing step (step P5) described below were carried out, it would be difficult to sufficiently remove the polishing agent from the glass substrate 1. Moreover, if chemical strengthening treatment were combined with the heat treatment in step P4 as described above, then places in which polishing agent was still attached to the surface of the glass substrate 1 would not be chemically strengthened, and there would be a risk of abnormal local depressions arising.

Next, the second washing step is carried out (step P5). The second washing step is carried out using approximately the same conditions and procedure as with the first washing step (step P3), and is comprised of a washing step using an acidic aqueous solution (step P5A) and a washing step using an alkaline aqueous solution (step P5B). Because permanent strain has been relaxed and polishing marks removed during the heat treatment (step P4) as described above, the surface of the glass substrate 1 has become uniform, and hence during the second washing step the surface of the glass substrate 1 is etched isotropically, and as a result undulations remaining on the glass substrate 1 are removed, and hence the surface smoothness and the cleanliness are improved.

In the second washing step (step P5), the glass substrate 1, which has been made uniform through the heat treatment (step P4), is thus etched once again with an acidic aqueous solution (step P5A) and an alkaline aqueous solution (step P5B). As a result, etching can be carried out at a uniform etching rate, and hence molten salt used in the chemical strengthening treatment and any foreign matter such as iron powder contained in the molten salt can be removed effectively, and moreover surface undulations can be reduced/removed effectively.

As described above, according to the present embodiment, a glass substrate 1 that has been precision polished (step P2) is subjected to a first washing step (step P3) in which etching is carried out using an acidic aqueous solution (step P3A) and an alkaline aqueous solution (step P3B) to remove polishing agent embedded in or fixed firmly to the surface of the glass substrate 1, is next subjected to a heating step (step P4) in which permanent strain is relaxed and hence polishing marks are removed and moreover chemical strengthening treatment is preferably carried out, and is then subjected to a second washing step (step P5) in which washing is once again carried out using an acidic aqueous solution (step P5A) and an alkaline aqueous solution (step P5B), this time to remove molten salt and surface undulations. As a result, a glass substrate can be manufactured that has excellent surface smoothness and cleanliness, thus enabling head crashes and thermal asperity to be substantially avoided during use as a magnetic disk substrate.

Moreover, because the glass substrate manufactured as described above has excellent surface smoothness and cleanliness, the glass substrate is suitable for use not only as a magnetic disk substrate, but also as a glass substrate for other information recording media such as an optical disk.

### EXAMPLES

As glass substrates, donut-shaped pieces of aluminosilicate glass (SiO₂: 66.0 mol %, Al₂O₃: 11.0 mol %, Li₂O: 8.0 mol %, Na₂O: 9.1 mol %, MgO: 2.4 mol %, Ca O: 3.6 mol %) having an outside diameter of 65 mm, an inside diameter of 20 mm, and a thickness of 0.61 mm were prepared.

Next, precision polishing was carried out in which each glass substrate was polished using a polishing agent comprised of CeO₂ abrasive grains (particle diameter: 1.2 μm) dispersed in a polishing liquid and suede type polishing pads made of artificial leather, and then the glass substrate was washed in a shower of pure water to roughly remove polishing agent attached to the surface of the glass substrate.

The glass substrates were then subjected to first washing treatment, heat treatment and second washing treatment in that order as described below, thus preparing test pieces of Examples 1 to 15 and Comparative Examples 1 to 6.

Note that the strain-removing point T of the glass substrates was 587° C.

### Example 1

A glass substrate that had been precision polished as described above was etched by immersing for 3 minutes in a 0.01 wt % hydrofluoric acid aqueous solution (temperature 50° C.) while irradiating with ultrasound of frequency 48 KHz and output power 1 W/cm². The glass substrate was then thoroughly washed by immersing in a bath of pure water. Next, the glass substrate was washed 3 times in a 10 wt % sodium hydroxide (NaOH) aqueous solution, and then the glass substrate was dried for 1 minute in IPA vapor, thus completing the first washing treatment.

Next, the glass substrate was put into an oven with the heat treatment temperature set to 340° C., and heat treatment was carried out for 120 minutes.

After the heat treatment, second washing treatment was then carried out using the same conditions and procedure as with the first washing treatment, thus preparing the test piece of Example 1.

### Example 2

First washing treatment was carried out using the same conditions and procedure as in Example 1, the glass substrate was then put into an oven with the heat treatment temperature set to 370° C. and heat treatment was carried out for 90 minutes, and then second washing treatment was carried out using the same conditions and procedure as in Example 1, thus preparing the test piece of Example 2.

### Example 3

First washing treatment was carried out using the same conditions and procedure as in Example 1, the glass substrate was then put into an oven with the heat treatment temperature set to 420°C. and heat treatment was carried out for 45 minutes, and then second washing treatment was carried out using the same conditions and procedure as in Example 1, thus preparing the test piece of Example 3.

### Example 4

First washing treatment was carried out using the same conditions and procedure as in Example 1, and then the glass substrate was immersed for 60 minutes in a molten salt prepared by mixing together 60 wt % of KNO₃ and 40 wt % of NaNO₃ (heat treatment temperature: 370° C.), thus carrying out heat treatment and at the same time carrying out chemical strengthening treatment in which Li⁺ and Na+ in the glass substrate are replaced through ion exchange with K⁺, which has a larger ionic radius than Li⁺ and Na⁺. Second washing treatment was then carried out using the same conditions and procedure as in Example 1, thus preparing the test piece of Example 4.

### Example 5

A glass substrate was etched by immersing for 3 minutes in sulfuric acid adjusted in concentration to a normality of 1N (hereinafter referred to merely as “1N”) (temperature 50° C.) while irradiating with ultrasound of frequency 48 KHz and output power 1 W/cm². The glass substrate was then thoroughly washed by immersing in a bath of pure water. Next, the glass substrate was washed 3 times in a 10 wt % sodium hydroxide (NaOH) aqueous solution, and then the glass substrate was dried for 1 minute in IPA vapor, thus completing the first washing treatment.

Heat treatment combined with chemical strengthening treatment was then carried out using the same conditions and procedure as in Example 4, and then second washing treatment was carried out using the same conditions and procedure as in Example 4, thus preparing the test piece of Example 5.

### Example ≢

The test piece of Example 6 was prepared using the same conditions and procedures as in Example 5, only except that 1N hydrochloric acid was used as the acidic aqueous solution in the first washing treatment in place of the sulfuric acid used in Example 5.

### Example 7

The test piece of Example 7 was prepared using the same conditions and procedures as in Example 5, only except that 1N nitric acid was used as the acidic aqueous solution in the first washing treatment in place of the sulfuric acid used in Example 5.

### Example 8

The test piece of Example 8 was prepared using the same conditions and procedures as in Example 5, only except that 1N sulfamic acid was used as the acidic aqueous solution in the first washing treatment in place of the sulfuric acid used in Example 5.

### Example 9

The test piece of Example 9 was prepared using the same conditions and procedures as in Example 5, only except that 1N phosphoric acid was used as the acidic aqueous solution in the first washing treatment in place of the sulfuric acid used in Example 5.

### Example 10

The test piece of Example 10 was prepared using the same conditions and procedures as in Example 5, only except that 1N acetic acid and 1N phosphoric acid were used as the acidic aqueous solutions in the first washing treatment and the second washing treatment respectively, in place of the sulfuric acid and hydrofluoric acid used in Example 5.

### Example 11

First washing treatment and heat treatment were carried out using the same conditions and procedures as in Example 4, and then second washing treatment was carried out as in Example 4 but using 1N sulfuric acid as the acidic aqueous solution and a 10 wt % sodium hydroxide aqueous solution as the alkaline aqueous solution, thus preparing the test piece of Example 11.

### Example

The test piece of Example 12 was prepared using the same conditions and procedures as in Example 11, only except that 1N hydrochloric acid was used as the acidic aqueous solution in the second washing treatment in place of the sulfuric acid used in Example 11.

### Example 13

The test piece of Example 13 was prepared using the same conditions and procedures as in Example 11, only except that 1N nitric acid was used as the acidic aqueous solution in the second washing treatment in place of the sulfuric acid used in Example 11.

### Example 14

The test piece of Example 14 was prepared using the same conditions and procedures as in Example 11, only except that 1N sulfamic acid was used as the acidic aqueous solution in the second washing treatment in place of the sulfuric acid used in Example 11.

### Example 15

The test piece of Example 15 was prepared using the same conditions and procedures as in Example 11, only except that 1N phosphoric acid was used as the acidic aqueous solution in the second washing treatment in place of the sulfuric acid used in Example 11.

### Comparative Example 1

A glass substrate that had been precision polished as described above was subjected directly to heat treatment and second washing treatment using the same conditions and procedures as in Example 4 without carrying out first washing treatment beforehand, thus preparing the test piece of Comparative Example 1.

### Ccomparative Example 2

A glass substrate that had been precision polished as described above was subjected to first washing treatment and heat treatment using the same conditions and procedures as in Example 4, thus preparing the test piece of Comparative Example 2. Note that second washing treatment was not carried out.

### Comparative Example 3

A glass substrate that had been precision polished as described above was subjected to first washing treatment in which etching with an acidic aqueous solution was not carried out, but rather the glass substrate was just washed 3 times in a 10 wt % sodium hydroxide aqueous solution and then dried for 1 minute in IPA vapor.

Heat treatment was then carried out using the same conditions and procedure as in Example 4, thus preparing the test piece of Comparative Example 3, without carrying out second washing treatment.

### Comparative Example 4

A glass substrate that had been precision polished as described above was subjected to first washing treatment in which etching with a hydrofluoric acid aqueous solution was carried out using the same conditions and procedure as in Example 1 but washing with an alkaline aqueous solution was not carried out. Heat treatment and second washing treatment were then carried out using the same conditions and procedures as in Example 4, thus preparing the test piece of Comparative Example 4.

### Comparative Example 5

A glass substrate that had been precision polished as described above was subjected to first washing treatment and heat treatment using the same conditions and procedures as in Example 4. Second washing treatment was then carried out in which the glass substrate was etched with a hydrofluoric acid aqueous solution using the same conditions and procedure as in the first washing treatment but washing with an alkaline aqueous solution was not carried out, thus preparing the test piece of Comparative Example 5.

### Comparative Example 6

A glass substrate that had been precision polished as described above was subjected to first and second washing treatment in that order using the same conditions and procedures as in Example 1, thus preparing the test piece of Comparative Example 6. Note that heat treatment was not carried out.

The surface roughness Ra of each of the above test pieces (Examples 1 to 15 and Comparative Examples 1 to 6) was measured after the precision polishing, after the first washing treatment, and after the second washing treatment.

The surface roughness Ra was measured using an AFM (atomic force microscope) with the measurement range set to 10 μm². The AFM was a Nanoscope III made by Digital Instruments Inc.

Moreover, the amount of residual cerium, the number of abnormal depressions and the number of luminescent spots were measured after the second washing treatment using the following methods, thus evaluating the cleanliness of the glass substrate.

(1) Amount of Residual Cerium

The glass substrate was immersed for about 15 minutes in concentrated sulfuric acid heated to 120° C. to dissolve the CeO₂, and then the quantity of Ce atoms was measured by ICP (inductively coupled plasma) spectrometry, and the amount of residual cerium was calculated, and hence the amount of residual polishing agent (loose abrasive grains) attached to the glass substrate was calculated.

(2) Number of Abnormal Depressions

The glass substrate was observed under a 100,000 lux halogen beam, and it was investigated whether or not there were abnormal depressions in the glass substrate. Specifically, depressions of diameter about 5 μm and depth about 1 μm or more can be seen under a 100,000 lux halogen beam, and hence the presence/absence of abnormal depressions was evaluated by the number of such depressions seen.

(3) Number of Luminescent Spots

Dark field observation was carried out using an optical microscope (Optiphot made by Nikon Corporation) set to a magnification of 200×, and the number of luminescent spots in 1 cm² of the dark field image was measured, and hence it was evaluated whether or not there was foreign matter such as polishing agent attached to the glass substrate. Specifically, foreign matter can be seen as a luminescent spot using an optical microscope at 200× magnification if the particle diameter of the foreign matter is about 0.5 μm, and hence luminescent spots are seen if foreign matter having a particle diameter of about 0.5 μm or more is present.

The manufacturing conditions, the surface roughnesses Ra and the cleanliness measurement results for each of the test pieces (Examples 1 to 15, Comparative Examples 1 to 6) are shown in Table 1.

TABLE 2

| | | First washing treatment | | Heat treatment | | | Second washing treatment | |
|---|---|---|---|---|---|---|---|---|
| | | Acidic aqueous | Alkaline aqueous | | Temperature | Time | Acidic aqueous | Alkaline aqueous |
| | | solution | solution | Medium | (° C.) | (min) | solution | solution |
| Example | 1 | Hydrofluoric acid | Sodium hydroxide | Air | 340 | 120 | Hydrofluric acid | Sodium hydroxide |
| | 2 | Hydrofluoric acid | Sodium hydroxide | Air | 370 | 90 | Hydrofluric acid | Sodium hydroxide |
| | 3 | Hydrofluoric acid | Sodium hydroxide | Air | 420 | 45 | Hydrofluric acid | Sodium hydroxide |
| | 4 | Hydrofluoric acid | Sodium hydroxide | Moltensalt | 370 | 60 | Hydrofluric acid | Sodium hydroxide |
| | 5 | Sulfuric acid | Sodium hydroxide | Moltensalt | 370 | 60 | Hydrofluric acid | Sodium hydroxide |
| | 6 | Hydrochloric acid | Sodium hydroxide | Moltensalt | 370 | 60 | Hydrofluric acid | Sodium hydroxide |
| | 7 | Nitric acid | Sodium hydroxide | Moltensalt | 370 | 60 | Hydrofluric acid | Sodium hydroxide |
| | 8 | Sulfamic acid | Sodium hydroxide | Moltensalt | 370 | 60 | Hydrofluric acid | Sodium hydroxide |
| | 9 | Phosphoric acid | Sodium hydroxide | Moltensalt | 370 | 60 | Hydrofluric acid | Sodium hydroxide |
| | 10 | Acetic acid | Sodium hydroxide | Moltensalt | 370 | 60 | Phosphoric acid | Sodium hydroxide |
| | 11 | Hydrofluoric acid | Sodium hydroxide | Moltensalt | 370 | 60 | Sulfuric acid | Sodium hydroxide |
| | 12 | Hydrofluoric acid | Sodium hydroxide | Moltensalt | 370 | 60 | Hydrofluric acid | Sodium hydroxide |
| | 13 | Hydrofluoric acid | Sodium hydroxide | Moltensalt | 370 | 60 | Nitric acid | Sodium hydroxide |
| | 14 | Hydrofluoric acid | Sodium hydroxide | Moltensalt | 370 | 60 | Sulfamic acid | Sodium hydroxide |
| | 15 | Hydrofluoric acid | Sodium hydroxide | Moltensalt | 370 | 60 | Phosphoric acid | Sodium hydroxide |
| Comparative | 1 | — | — | Moltensalt | 370 | 120 | Hydrofluric acid | Sodium hydroxide |
| example | 2 | Hydrofluoric acid | Sodium hydroxide | Moltensalt | 370 | 120 | — | — |
| | 3 | — | Sodium hydroxide | Moltensalt | 370 | 120 | — | — |
| | 4 | Hydrofluoric acid | — | Moltensalt | 370 | 120 | Hydrofluric acid | Sodium hydroxide |
| | 5 | Hydrofluoric acid | Sodium hydroxide | Moltensalt | 370 | 120 | Hydrofluric acid | — |
| | 6 | Hydrofluoric acid | Sodium hydroxide | — | — | — | Hydrofluric acid | Sodium hydroxide |

| | | Surface roughness | | | Cleanliness | | |
|---|---|---|---|---|---|---|---|
| | | | After first | After second | Amount of | No. of abnormal | No. of luminescent |
| | | After polishing | washing treatment | washing treatment | residual cerium | depressions | spots |
| | | Ra (nm) | Ra (nm) | Ra (nm) | (μg/substrate) | per substrate | per cm² |
| Example | 1 | 0.25 | 0.75 | 0.23 | Below detection limit | 0 | 0.7 |
| | 2 | 0.25 | 0.75 | 0.22 | Below detection limit | 0 | 0.6 |
| | 3 | 0.25 | 0.75 | 0.23 | Below detection limit | 0 | 0.8 |
| | 4 | 0.25 | 0.75 | 0.23 | Below detection limit | 0 | 1 |
| | 5 | 0.25 | 0.5 | 0.2 | Below detection limit | 0 | 0.9 |
| | 6 | 0.25 | 0.5 | 0.19 | Below detection limit | 0 | 1.3 |
| | 7 | 0.25 | 0.4 | 0.24 | Below detection limit | 0 | 1.7 |
| | 8 | 0.25 | 0.6 | 0.2 | Below detection limit | 0 | 1.4 |
| | 9 | 0.25 | 0.4 | 0.19 | Below detection limit | 0 | 2.3 |
| | 10 | 0.25 | 0.57 | 0.23 | Below detection limit | 0 | 3.1 |
| | 11 | 0.25 | 0.75 | 0.23 | Below detection limit | 0 | 0.7 |
| | 12 | 0.25 | 0.75 | 0.23 | Below detection limit | 0 | 0.9 |
| | 13 | 0.25 | 0.75 | 0.23 | Below detection limit | 0 | 0.8 |
| | 14 | 0.25 | 0.75 | 0.23 | Below detection limit | 0 | 0.9 |
| | 15 | 0.25 | 0.75 | 0.23 | Below detection limit | 0 | 1.3 |
| Comparative | 1 | 0.25 | — | 0.22 | Below detection limit | 9 | 18.5 |
| example | 2 | 0.25 | — | 1.22 | Below detection limit | 0 | 21 |
| | 3 | 0.25 | — | 0.31 | 17 | 10 | 19 |
| | 4 | 0.25 | 0.75 | 0.23 | Below detection limit | 6 | 5.3 |
| | 5 | 0.25 | 0.75 | 0.23 | Below detection limit | 0 | 7 |
| | 6 | 0.25 | 0.75 | 0.86 | Below detection limit | 0 | 0.7 |

It can be seen from Table 1 that, because the precision polishing was carried out under the same conditions in all cases, the surface roughness Ra after the precision polishing exhibited the same value of 0.25 nm in all cases.

Moreover, because the first washing treatment was carried out in a state in which polishing marks still remained on the surface of the glass substrate, the etching was not carried out uniformly, and hence the surface roughness Ra of the glass substrate after the first washing treatment was greater than after the precision polishing in all cases.

Regarding Comparative Example 1, the surface roughness Ra after the second washing treatment was 0.22 nm, and hence the surface smoothness was good. However, the number of abnormal depressions observed was high at 9 per substrate, and the number of luminescent spots was high at 18.5 per cm², and hence the cleanliness was poor. It is thought that the reason for this is that, because first washing treatment was not carried out before the heat treatment, the heat treatment was carried out under a state in which CeO₂ abrasive grains were still embedded in or fixed firmly to the surface of the glass substrate in places, and hence these CeO₂ abrasive grains could not be removed sufficiently.

Moreover, regarding Comparative Example 2, the surface roughness Ra at the end was 1.22 nm, which was much higher than after the polishing, and moreover the number of luminescent spots was high at 21 per cm², showing that the cleanliness was poor. It is thought that the reason for this is that, because second washing treatment was not carried out after the heat treatment, molten salt used in the heat treatment and also impurities in this molten salt remained attached to the glass substrate and could not be removed.

Regarding Comparative Example 3, etching in a sodium hydroxide aqueous solution was carried out during the first washing treatment even though etching in an acidic aqueous solution was not carried out, and hence the surface roughness at the end was relatively good at 0.31 nm. However, the amount of residual cerium was high at 17 μg per substrate, and the number of abnormal depressions and the number of luminescent spots were also high at 10 per substrate and 19 per cm² respectively, showing that the cleanliness was poor. It is thought that the reason for this is that, because etching with an acidic aqueous solution was not carried out during the first washing treatment, CeO₂ abrasive grains remained embedded in or firmly fixed to the surface of the glass substrate, and moreover because second washing treatment was not carried out, molten salt used in the heat treatment and also impurities in this molten salt remained attached to the glass substrate and could not be removed.

Regarding Comparative Example 4, a good surface roughness Ra of 0.23 nm was obtained at the end, but the number of abnormal depressions and the number of luminescent spots were high at 6 per substrate and 5.3 per cm² respectively, showing that the cleanliness was poor. It is thought that the reason for this is that, because washing with an alkaline aqueous solution was not carried out during the first washing treatment, it was not possible to completely remove CeO₂ abrasive grains that reattached to the glass substrate during washing in the hydrofluoric acid aqueous solution.

Regarding Comparative Example 5, a good surface roughness Ra of 0.23 nm was obtained at the end, but the number of luminescent spots observed was high at 7 per cm². It is thought that the reason for this is that, because washing with an alkaline aqueous solution was not carried out during the second washing treatment, no electrostatic repulsion acted between the glass substrate 1 and foreign matter in the washing solution, and hence foreign matter could not be completely removed from the glass substrate 1.

Regarding Comparative Example 6, because first and second washing treatments were both carried out in full, a satisfactory cleanliness was obtained. However, because heat treatment was not carried out, permanent strain generated through the polishing was not relaxed, and thus polishing marks remained, and hence it was found that the surface roughness Ra after the second washing treatment was much higher at 0.86 nm than after the precision polishing, i.e. that the surface smoothness worsened.

In contrast with the above, in the case of Examples 1 to 3, the surface roughness Ra increased to 0.75 nm after the first washing treatment, but after carrying out heat treatment and thus relaxing permanent strain, second washing treatment was carried out, and hence the surface roughness dropped back down to 0.22 to 0.23 nm. An excellent surface smoothness was thus obtained. Moreover, regarding the cleanliness, the amount of residual cerium was below the detection limit and hence abnormal depressions were not observed, and the number of luminescent spots was extremely low at 0.6 to 0.8 per cm². A good cleanliness was thus obtained.

Moreover, regarding Example 4, the heat treatment was carried out in a molten salt, but an excellent surface roughness and cleanliness about the same as for Examples 1 to 3 were still obtained.

Regarding Examples 5 to 9, various strong acids were used as the acidic aqueous solution in the first washing treatment. The surface roughness Ra was 0.19 nm to 0.24 nm at the end, and hence an excellent surface smoothness was obtained. Moreover, the amount of residual cerium was below the detection limit and hence no abnormal depressions were observed, and the number of luminescent spots was low at 0.9 to 2.3 per cm², showing that a good cleanliness was obtained.

Regarding Example 10, acetic acid, which is a weak acid, was used as the acidic aqueous solution in the first washing treatment. The number of luminescent spots was slightly higher at 3.1 per cm² and hence the cleanliness slightly reduced compared with Examples 1 to 4 in which hydrofluoric acid was used and Examples 5 to 9 in which other strong acids were used, but nevertheless a good surface smoothness and a satisfactory cleanliness were obtained. It was thus verified that a satisfactory surface smoothness and cleanliness can be obtained even if washing is carried out using a weak acid.

Regarding Examples 11 to 15, various strong acids were used as the acidic aqueous solution in the second washing treatment. The surface roughness Ra was 0.23 nm at the end, and hence an excellent surface smoothness was obtained. Moreover, the amount of residual cerium was below the detection limit and hence no abnormal depressions were observed, and the number of luminescent spots was low at 0.7 to 1.3 per cm², showing that a good cleanliness was obtained.

What is claimed is:

1. A method of manufacturing a glass substrate for information recording media, comprising the steps of:
precision polishing a glass substrate;
subjecting the glass substrate to first washing treatment using an acidic aqueous solution and an alkaline aqueous solution;
subjecting the glass substrate to heat treatment; and
subjecting the glass substrate to second washing treatment using an acidic aqueous solution and an alkaline aqueous solution.

2. A method of manufacturing a glass substrate for information recording media as claimed in claim 1, wherein a treatment temperature of the heat treatment is not less than (T−200)° C., wherein T represents an annealing temperature corresponding to a strain-removing point of the glass substrate.

3. A method of manufacturing a glass substrate for information recording media as claimed in claim 1, wherein a treatment temperature of the heat treatment is not more than T° C., wherein T represents an annealing temperature corresponding to a strain-removing point of the glass substrate.

4. A method of manufacturing a glass substrate for information recording media as claimed in any one of claims 1 through 3, wherein the heat treatment is carried out in a liquid.

5. A method of manufacturing a glass substrate for information recording media as claimed in claim 4, wherein the liquid is a molten salt, and the heat treatment includes chemical strengthening treatment wherein some ions of chemical components constituting the glass substrate are replaced with ions contained in the molten salt having a larger ionic radius than the some ions of the chemical components constituting the glass substrate.

6. A method of manufacturing a glass substrate for information recording media as claimed in claim 1, wherein the acidic aqueous solution contains at least one acid selected from the group consisting of hydrofluoric acid, silicofluoric acid, sulfuric acid, hydrochloric acid, nitric acid, sulfamic acid and phosphoric acid.

7. A method of manufacturing a glass substrate for information recording media as claimed in claim 1, wherein the alkaline aqueous solution comprises an aqueous solution of a water-soluble alkaline material, and further contains at least one component selected from surfactants and chelating agents.

8. A glass substrate for information recording media manufactured by a method as claimed in any one of claims 1 to 3 and claims 6 and 7.
